(19) United States
(12) Patent Application Publication
(10) Pub. No.: US 2002/0044792 A1
(43) Pub. Date: Apr. 18, 2002

(54) Image forming apparatus

(76) Inventor: Tadao Uehara, Hyogo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/974,839

(22) Filed: Oct. 12, 2001

(30) Foreign Application Priority Data
Oct. 13, 2000 (JP) 2000-313292

(51) Int. Cl. G03G 15/16

(52) U.S. Cl. 399/122

(57) ABSTRACT

An image forming apparatus of the present invention includes an apparatus body, a heat roller, a fixing roller, a press roller pressed against the fixing roller, an endless belt passed over the heat roller and fixing roller, and a tension roller applying tension to the endless belt. The heat roller, fixing roller, endless belt and tension roller are constructed into a unit member, which is removably mounted to apparatus body.

### BACKGROUND OF THE INVENTION

1. Field of the Invention

The present invention relates to a copier, laser printer, facsimile apparatus or similar image forming apparatus.

2. Description of the Background Art

Japanese Patent Laid-Open Publication No. 5-27623, for example, discloses an image forming apparatus including a fixing device generally made up of a heat roller, a fixing roller, an endless belt passed over the two rollers, a press roller pressed against the fixing roller with the intermediary of the belt, and a tension roller for applying tension to the belt. A paper sheet or similar recording medium carrying a toner image thereon is conveyed via a nip between the press roller and the belt, so that the toner image is fixed on the paper sheet. The heat roller or the press roller accommodates a halogen lamp or similar heater. A coating roller coats silicone oil on the belt in order to promote parting of the paper sheet from the belt after fixation.

In the image forming apparatus of the type described, all the structural elements including the belt, heat roller, fixing roller, press roller, tension roller and coating roller are mounted on the apparatus body integrally with each other. This, coupled with the heater disposed in the heat roller or the press roller, increases the number of parts to assemble and complicates the structure. Further, the structural elements are difficult to handle because they are apt to break when the belt is inserted into the apparatus body or at the time of maintenance. Moreover, when the belt is replaced, the oil smears the operator's hand. The conventional apparatus is therefore not desirable from the production, assembly and maintenance standpoint.

Technologies relating to the present invention are also disclosed in, e.g., Japanese Patent Laid-Open publication No. 2000-66541.

### SUMMARY OF THE INVENTION

It is therefore an object of the present invention to provide an image forming apparatus that promotes easy, efficient mounting of a fixing device to an apparatus body and facilitates the maintenance of the fixing device.

An image forming apparatus of the present invention includes an apparatus body, a heat roller, a fixing roller, a press roller pressed against the fixing roller, an endless belt passed over the heat roller and fixing roller, and a tension roller applying tension to the endless belt. The heat roller, fixing roller, endless belt and tension roller are constructed into a unit member, which is removably mounted to apparatus body.

### BRIEF DESCRIPTION OF THE DRAWING

The above and other objects, features and advantages of the present invention will become more apparent from the following detailed description taken with the accompanying drawing in which:

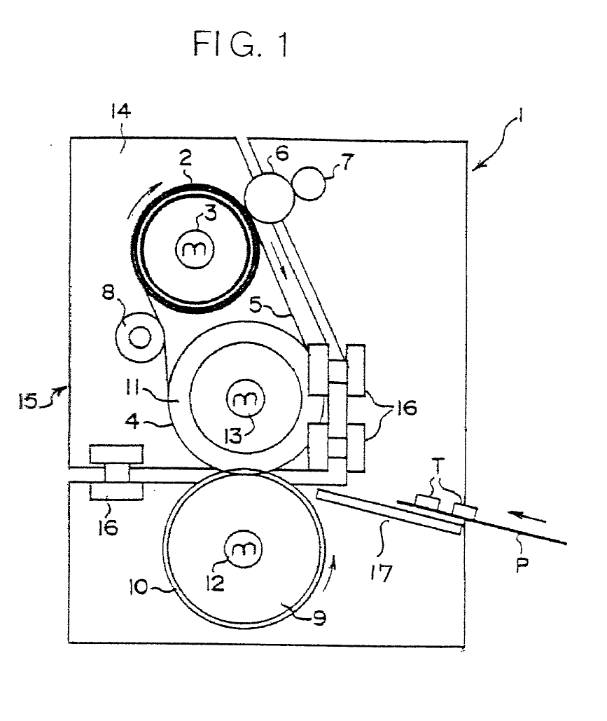

A single FIG. 1 is a section showing an image forming apparatus embodying the present invention.

### DESCRIPTION OF THE PREFERRED EMBODIMENT

Referring to a single FIG. 1 of the drawings, an image forming apparatus embodying the present invention is shown and includes a casing 1. The casing 1 accommodates a heat roller 2, a fixing roller 4, an endless belt 5, a coating roller 6, an oil feed roller 7, a tension roller 8, and a press roller 9. Heaters 3 and 13 are disposed in the heat roller 2 and fixing roller 4, respectively. It is to be noted that even only one of the two heaters 3 and 13 suffices for heating the belt 5. A rubber layer 11 covers the surface of the fixing roller 4. The belt 5 is passed over the heat roller 2 and fixing roller 4. The coating roller 6 coats oil on the surface of the belt 5 while the oil feed roller 7 feeds the oil to the coating roller 6. The tension roller 8 applies tension to the belt 5. A rubber layer 10 is formed on the surface of the press roller 9. A heater 12 is disposed in the press roller 9. The fixing roller 4 and press roller 9 are pressed against each other with the intermediary of the belt 5.

The belt 5, fixing roller 4, heat roller 2 and tension roller 8 are constructed into a unit and removably mounted to a support 14, constituting a unit member 15. The unit member 15 is removably mounted to the apparatus body 1 by three fixing members 16 at one side, i.e., six fixing members 16 at both sides.

The belt 5 has a base formed of polyimide resin or SUS (chrome stainless steel as prescribed by JIS (Japanese Industrial Standards)), nickel or similar metal. A silicone rubber layer covers the surface of the base and plays the role of a parting layer. The coating roller 6 is positioned upstream of the fixing roller 4 in the direction of movement of the belt 5 in order to feed the oil to the belt 5, thereby promoting parting of a paper sheet or similar recording medium. Also, the tension roller 8 is positioned downstream of the fixing roller 4 so as not to effect the coating of the oil.

In operation, the heat roller 2 heats the belt 5 in contact with the belt 5, which is running in a direction indicated by an arrow in FIG. 1. A paper sheet or similar recording medium P carrying a toner image T, which is formed by a conventional image forming process, is conveyed to a nip between the belt 5 and the press roller 9 along a guide 17. The belt 5 and press roller 9 press the paper sheet P therebetween with the result that the toner image T is fixed on the paper sheet P by heat and pressure. The paper sheet P coming out of the above nip is driven out of the apparatus body 1.

As stated above, in the illustrative embodiment, the heat roller 2, fixing roller 4, belt 5 and tension roller 8 are constructed into a single unit member 15. The unit member 15 is removably mounted to the apparatus body 1 by the fixing members 16. Terminals for connecting the heaters 3 and 13 are also arranged on the unit member 15. This reduces the number of parts to be assembled on the apparatus body 1 and thereby simplifies the overall structure of the apparatus while promoting easy production and assembly.

Further, maintenance, e.g., the replacement of the belt 5 can be performed only if the unit member 15 is removed from the apparatus body 1. The operator is therefore free from smears and can easily perform maintenance. Moreover, such a simple structure protects the structural parts from damage otherwise occurring when the belt 5 is inserted into the apparatus body 1. In addition, the oil feed roller 7 is mounted on the apparatus body 1 and reduces the number of parts of the unit member 15.

It is to be noted that the number of fixing members 16 is, of course, open to choice.

In summary, it will be seen that the present invention provides an image forming apparatus having various unprecedented advantages, as enumerated below.

(1) At least a belt, a heat roller, a fixing roller and a tension roller are constructed into a single unit member, which is removably mounted to the apparatus body. This reduces the number of parts to be assembled on the apparatus body and thereby simplifies the overall structure of the apparatus while facilitating the replacement of parts. The apparatus is therefore easy to handle and assemble at the time of production

(2) Terminals for connecting a heater disposed in at least one of the heat roller and fixing roller is arranged on the unit member. This facilitates the removable of the unit member from the apparatus body and further reduces the number of parts to be assembled on the apparatus body. Consequently, the structure of the apparatus is further simplified and becomes easier to handle and assemble at the time of production. In addition, such a simple structure protects the structural parts from damage otherwise occurring when the belt is inserted into the apparatus body.

(3) An oil coating mechanism is mounted on the apparatus body and allows its coating roller and oil feed roller to be accurately positioned, further enhancing easy production and assembly. In addition, the replacement of the belt or similar maintenance can be performed only if the unit member is removed from the apparatus body, freeing the operator from smears.

Various modifications will become possible for those skilled in the art after receiving the teachings of the present disclosure without departing from the scope thereof.

What is claimed is:

1. An image forming apparatus comprising:
an apparatus body;
a heat roller;
a fixing roller;
a press roller pressed against said fixing roller;
an endless belt passed over said heat roller and said fixing roller; and
a tension roller applying tension to said endless belt;
wherein said heat roller, said fixing roller, said endless belt and said tension roller are constructed into a unit member, which is removably mounted to said apparatus body.

2. The apparatus as claimed in claim 1, further comprising coating means for coating oil on said endless belt.

3. The apparatus as claimed in claim 1, wherein said at least one of said heat roller and said fixing roller accommodates a heater therein.

4. The apparatus as claimed in claim 3, further comprising a terminal for connecting said heater.

5. The apparatus as claimed in claim 4, wherein said terminal is arranged on said unit member.

6. The apparatus as claimed in claim 5, further comprising coating means for coating oil on said endless belt.
